(19) United States
(12) Patent Application Publication
(10) Pub. No.: US 2014/0093071 A1
(43) Pub. Date: Apr. 3, 2014

(54) SUPPORT OF MULTIPLE PDN CONNECTIONS OVER A TRUSTED WLAN ACCESS

(71) Applicant: Zu Qiang, Kirkland (CA)

(72) Inventor: Zu Qiang, Kirkland (CA)

(73) Assignee: TELEFONAKTIEBOLAGET L M ERICSSON (PUBL), Stockholm (SE)

(21) Appl. No.: 14/044,470

(22) Filed: Oct. 2, 2013

Related U.S. Application Data
(60) Provisional application No. 61/708,899, filed on Oct. 2, 2012.

(51) Int. Cl. H04W 12/06

(52) U.S. Cl. CPC H04W 12/06
USPC 380/33

(57) ABSTRACT

Modifications to authentication and authorization messages are used to allow an authentication server to query both an access network and a terminal device connecting over the access network to determine whether both nodes support the terminal device forming a plurality of packet data network connections that can support tunnels. This allows a non-3GPP access network to offer terminal devices the ability to connect to a 3GPP core network with multiple connections.

### CROSS REFERENCE TO RELATED APPLICATIONS

This application claims the benefit of priority to U.S. Provisional Patent Application No. 61/708,899, filed Oct. 2, 2012, the contents of which are incorporated herein by reference.

### TECHNICAL FIELD

This disclosure relates generally to management of multiple PDN connections over a trusted WLAN access. It also makes use of a tunnel based protocol (e.g. IKEv2) to distinguish different PDN connections.

### BACKGROUND

In a fixed mobile convergence (FMC) environment, the assumption is that the terminal device such as a user equipment (UE) has a dual-radio or a multi-radio setup. A UE has a first radio interface for the 3GPP access (e.g. LTE), and another radio interface for the fixed access (WiFi). In 3GPP, “Study on Support of BBF Access Interworking” (BBAI) covers interworking between 3GPP (the standardization organization for mobile networks) and BBF (the standardization organization for fixed networks). Another work item in 3GPP, “Study on S2a Mobility based On GTP & WLAN access to EPC” (SaMOG) covers the standardization of a 3GPP network interworking with a WiFi radio access. Additional standardization activities are ongoing in WiFi Alliance.

A 3GPP UE can attach to a non-3GPP access network (e.g. a fixed network such as a WiFi network) and get connected to one or more PDNs (Packet Data Networks) via the S2 interface. Each PDN connection is anchored in a 3GPP PGW (PDN GateWay). The UE typically receives one IP address for each PDN connection. It is the PGW that assigns the address.

The S2 interface comes in three flavors; S2a, S2b and S2c. The latter two overlay the non-3GPP access network and do not impact it. S2a is a more converged solution that does impact the non-3GPP access. In S2a, the non-3GPP access network is seen as trusted. This is denoted as TNAN (Trusted Non-3GPP Access Network). In case the TNAN uses WLAN as radio technology towards the UEs, the TNAN is denoted as TWAN (Trusted WLAN Access Network).

S2a over TWAN is now standardized in 3GPP. In 3GPP Rel 11, S2a over TWAN is restricted to support only a single PDN connection per UE. Additionally, the UE cannot specify an APN and handover is not supported. As a result, S2a over TWAN does not impose any requirements on the UE; in other words—an “unmodified UE” can be used.

There are a number of different scenarios in which these limitations cause problems. Therefore, it would be desirable to provide a system and method that obviate or mitigate the above described problems

### SUMMARY

It is an object of the present invention to obviate or mitigate at least one disadvantage of the prior art.

In a first embodiment of the present invention, there is provided a method for configuring access to a Third Generation Partnership Project (3GPP) compliant packet data network by a terminal device connecting through a trusted non-3GPP access network. The method comprises the steps of receiving, over a communication interface, from a node in the trusted non-3GPP access network, an indication that the trusted non-3GPP access network supports the establishment of a plurality of connections between the terminal device and a packet data network; receiving, over the communication interface, from the terminal device an indication that the terminal device supports a plurality of connections to the packet data network; authenticating the terminal device for access to the packet data network; transmitting, over the communication interface, to the terminal device an indication of network support for a plurality of packet data network over the trusted non-3GPP access network; and transmitting, over the communication interface, to the node in the trusted non-3GPP access network an indication of a decision to support the establishment of a plurality of connections between the terminal device and a packet data network over the trusted non-3GPP access network.

In an embodiment of the first aspect of the present invention, the terminal device is a User Equipment device. In another embodiment of the first aspect of the present invention, the trusted non-3GPP access network is a Wi-Fi based network.

In a further embodiment, the received indication form the node in the trusted non-3GPP access network is an indication provided as part of a Diameter/RADIUS message. In another embodiment, the indication received from the terminal device is received in an Extensible Authentication Protocol (EAP) message, and optionally the EAP message is an Extensible Authentication Protocol (EAP) Authentication and Key Agreement challenge message. In another embodiment, the indication transmitted to the terminal device is transmitted in an Extensible Authentication Protocol (EAP) Notification message. In a further embodiment, the indication transmitted to the node in the trusted non 3-GPP access network is transmitted in a Diameter/RADIUS success message.

In another embodiment, the indication received from the terminal device is received in a request to establish a connection to the packet data network, and the step of authenticating is performed in response to the receipt of the request to establish the connection. Additionally, the method may further include the steps of receiving from the terminal device a subsequent request to establish a connection to the packet data network; updating a packet data network gateway in response to the received subsequent request; and transmitting towards the terminal device an authentication for use in establishing a subsequent connection to the packet data network while an initial connection to the packet data network is active.

In a second aspect of the present invention, there is provided an Authentication Authorization and Accounting server. The server allows for configuring access to a method for configuring access to a Third Generation Partnership Project (3GPP) compliant packet data network by a terminal device connecting through a trusted non-3GPP access network. The server comprises a network interface, a processor and a memory. The network interface allows for communicating with nodes in the trusted non-3GPP access network. The processor executes stored instructions. The memory stores instructions that when executed by the processor cause the Authentication Authorization and Accounting server to: determine that a communication received from a first node in the trusted non-3GPP access network includes an indication that the trusted non-3GPP access network supports the establishment of a plurality of connections between the terminal device and a packet data network, determine that a communication received from the terminal device includes an indication that the terminal device supports a plurality of connections to the packet data network, authenticate the terminal device for access to the packet data network, transmit to the terminal device over the network interface an authentication result including an indication of network support for a plurality of packet data network; and transmit to the first node an indication of a decision to support the establishment of a plurality of connections between the terminal device and the packet data network over the trusted non-3GPP access network.

In embodiments of the second aspect of the present invention, the terminal device is a user equipment device, and the trusted non-3GPP access network is a Wi-Fi based network.

In another embodiment of the second aspect, the memory further includes instructions that when executed by the processor cause the server to: determine that a subsequent communication received from the terminal device, includes a subsequent request to establish a connection to the packet data network, transmit an update message towards a packet data network gateway in response to the received subsequent request, and transmit towards the terminal device an authentication for use in establishing a subsequent concurrent connection to the packet data network.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a call flow diagram illustrating an exemplary Access Authentication (EAP/RADIUS) procedure;

FIG. 2 is a call flow diagram illustrating an exemplary Authentication based on EAP AKA procedure;

FIG. 3 is an exemplary call flow for an initial attach procedure in WLAN on GTRP S2a;

FIG. 4 is an exemplary call flow for an initial attach procedure in WLAN on PMIP S2a;

FIG. 5 is an exemplary call flow for an UE initiated additional PDN in a trusted WLAN; and

FIG. 6 is a block diagram of an exemplary node for use in an embodiment of the present invention.

### DETAILED DESCRIPTION

The present invention is directed to management of multiple PDN connections over a trusted wireless local area network (WLAN) access.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

In 3GPP Rel 11 there are no means to manage PDN connections over “native” Wi-Fi Access. A Layer-3 (L3) tunneling solution such as IPSec can be used but has disadvantages. For example, an L3 tunneling solution will typically be transparent to the underlying WLAN access network and thus have limitations in the QoS control that can be provided. There is also more overhead involved. Typically, L3 solutions are also not backwards compatible with the S2a-over-TWAN solution specified in 3GPP rel-11.

For native WLAN access, DHCP is typically used to request an IP address. DHCP however may not always be a suitable protocol for managing PDN connections, primarily since there is no clear means to tear down an IP connection. Furthermore, many terminal vendors are not in favor of modifying the DHCP implementations in the terminal in order to enhance them with additional functionality. DHCP is an established protocol and the implementation of modifications may not be easy to manage or may not even be fully under the terminal vendor's control.

Tunneling solutions below L3 can address many of these problems. A tunnel can be used to carry a PDN connection, and multiple PDN connections can be provided through the implementation of a plurality of tunnels. Many of the previously proposed solutions describe the (user plane) traffic separation mechanism once the tunnel is setup. A control protocol is needed for setup, maintenance and removal of a tunnel.

The following discussion defines a trusted WLAN (TWAN) attachment procedure. The following primitives, not all of which are required to be satisfied in each embodiment, are defined:
1. During an access attachment procedure, the WLAN access network can indicate its network capability to the 3GPP AAA using techniques such as RADIUS/Diameter attributer. The network capability information will include in a presently preferred embodiment the support of tunnel based multiple PDN connection functions and optionally the corresponding tunnel end point address.
2. The UE or other such terminal device may also need to indicate the support o of tunnel based multiple PDN connection function to the 3GPP AAA in an EAP attributer.
3. The 3GPP AAA may make the decision if the UE is allowed to access the TWAN with multiple PDN connections, single PDN connection or NSWO only. The decision may be made based on the subscription associated with the terminal device and policies, including querying the HSS/HLR. If a configuration supporting multiple PDN connections is allowed for the UE, the 3GPP AAA can respond to the UE using an EAP attribute with an indicator and the received co-responding tunnel end point address if it is received from the TWAN. The indicator indicates to the UE that tunnel based multiple PDN connection is supported.
4. The 3GPP AAA can also inform the TWAN of its multiple PDN connection decision using RADIUS/Diameter attributer.
5. Once the network indicator of multiple PDN connection is received, the UE can request an IP address from the TWAN using existing protocol (e.g. DHCP). The allocated IP address may be used for non-seamless offloading only.
6. When a PDN connection is needed, the setup procedure can be initiated by the UE using a tunnel based protocol procedure (including such prior art solutions as IKEv2). The received corresponding IPSec tunnel end point address is used as the tunnel based protocol peer node for the PDN connection setup procedure.

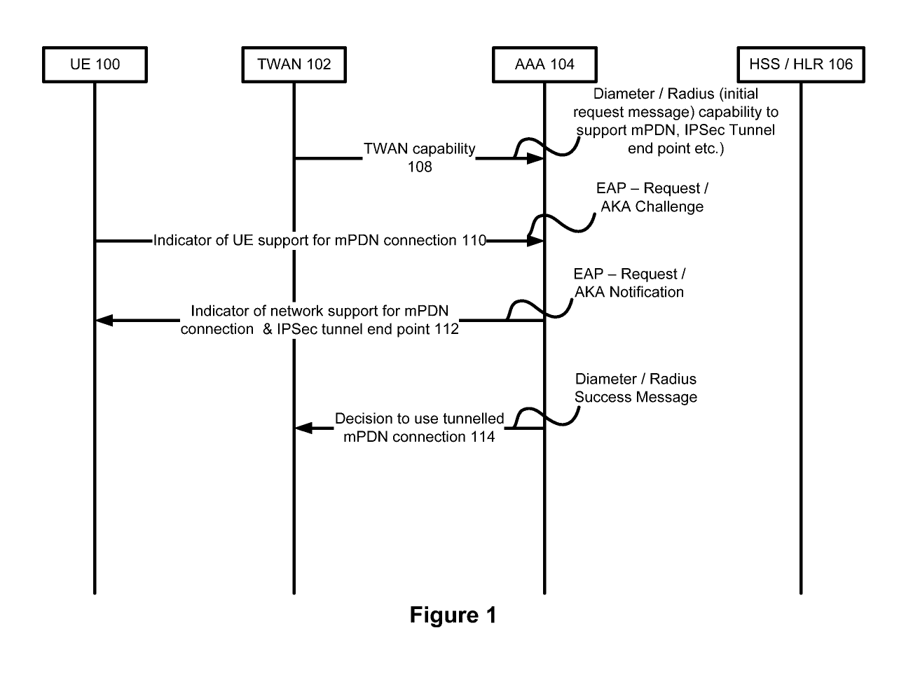

In FIG. 1, a logical overview of the relevant information elements in EAP and AAA protocols are shown. Note that this figure only shows a subset of the messages to illustrate the exchange of information elements for support of tunnel based multiple PDN connection function over the attached TWAN.

Prior to being contacted by UE 100, AAA 104 receives from TWAN 102 an indication 108 of the various connection features for which TWAN 102 offers support. This indication can be provided in any number of different manners including as a Diameter/RADIUS communication such as an Initial Request Message. The AAA 104 will use the information provided by TWAN 102 when it receives message 110 from UE 100. Message 110 is typically a request for service, such as an EAP Request/AKA challenge, and includes from UE 100 an indication of support for mPDN connections. AAA 104 replies to message 110 with indication 112 that the network supports mPDN connections, and provides and IPSec tunnel end point. This message 112 may be an EAP Request/AKA notification, which is optional in EAP-AKA. Following message 112, AAA 104 sends an indication 114 to TWAN 102 of the Access Authentication decision to use the tunnel mPDN connection.

The Access Authentication procedure of FIG. 1 need not be a standalone procedure but rather it can be part of the Initial Attach and Handover procedures. However, since the exemplary solution described below uses extensions to EAP and AAA protocol, the access authentication procedure is further detailed below.

The Evolved Packet Core (EPC) standards typically use EAP-AKA′ for access authentication in trusted WLAN networks. However, an alternate implementation of mobility and non-default APN can be based on EAP-SIM and EAP-AKA.

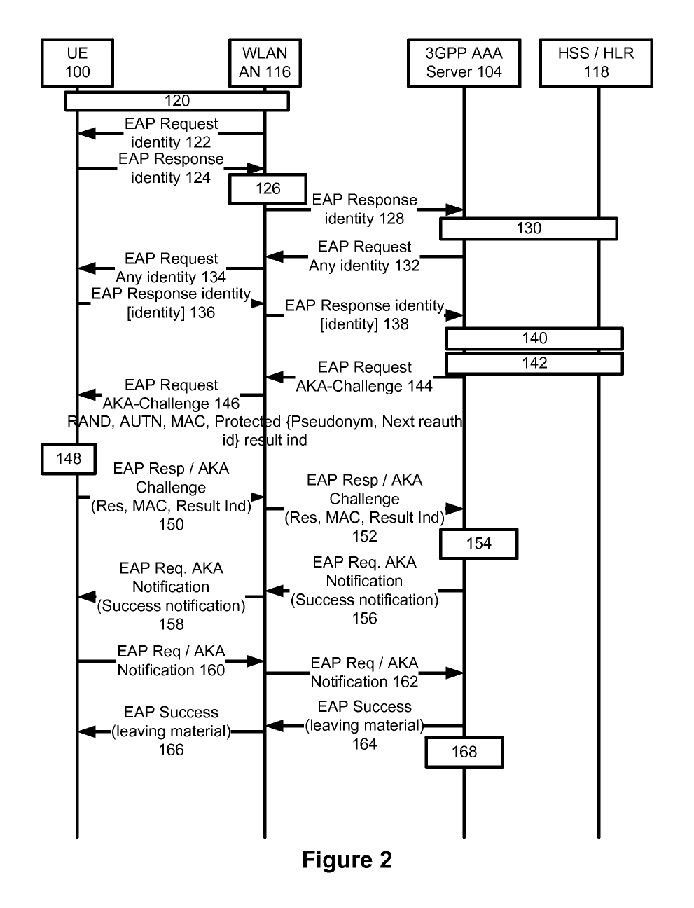

In FIG. 2, a more detailed call flow for EAP-AKA is shown. Not all details are described. As will be understood by those skilled in the art, the extension to EAP-SIM and EAP-AKA′ are similar but would include the extension specific variations.

In step 120, UE 100 connects to WLAN Access Network 116. In step 122, an EAP request for identity is made towards the UE 100. the UE responds with EAP Response/Identity 124. This response may be based on identifying information such as pseudonym or an IMSI value). In message 126, the WLAN AN 116 determines that the UE should be authenticated by the 3GPP AAA server 104, and accordingly it sends EAP Response/Identity towards the 3GPP AAA server 104. The 3GPP AAA Server 104 receives the EAP Response/Identity packet, sent in message 126, which contains the subscriber identity and additional information. Message 126 may contain an indication on whether the WLAN AN 116 supports tunnel based multiple PDN connection for S2a and the tunnel end point address. This information may be included on RADIUS/Diameter level and not within EAP message.

Based on the contents of message 126, 3GPP AAA server 104 communicates with the HSS/HLR 118 to authenticate UE 100. the EAP Request/AKA Identity message 132 is then sent to the WLAN AN 116, and forwarded on to the UE 100 in message 134. Messages 132 and 134 can provide any identity information, but the UE EAP Response/AKA Identity 136 which is sent to WLAN AN 116, and then forwarded in message 138 to the 3GPP AAA server 104 includes the terminal device identity. In step s 140 and 142, the 3GPP AAA server 104 and the HSS/HLR 118 create authentication challenges for the UE using conventional techniques that are outside the scope of the present disclosure.

In message 144, sent by the 3GPP AAA server 104 to the WLAN AN 116, an EAP Request/AKA Challenge including a random (or pseudo random) value, a authentication token, a MAC address, along with a preferably protected data set containing a pseudonym, and the next re-authentication identifier, and a result index. This EAP Request is forwarded to the UE 100 as message 146. In step 148, the UE 100 determines its response.

The UE 100 sends EAP Response/AKA-Challenge 150 containing calculated RES and the new calculated MAC value to WLAN AN 116.The UE 100 can indicate in EAP 150 whether it supports tunnel based multiple PDN connections. This information is provided within EAP message 150. WLAN AN 116 then provides the received response 150 to the 3GPP AAA server 104 as message 152. 3GPP AAA server 104 then, in step 154, checks the received MAC and compares XRES to the received RES. The 3GPP AAA Server 104 determines based on subscription data, configuration and on information received from the WLAN AN whether tunnel based multiple PDN connections is allowed for the UE 100.

If all checks in step 154 are successful, the 3GPP AAA Server 104 can send the message EAP Request/AKA-Notification 156, containing the EAP Success message, if the 3GPP AAA Server 104 requested previously to use protected successful result indications, this message may be MAC protected. The message 156 may also contain an indicator to the UE 100 that tunnel based multiple PDN connection is supported and the corresponding tunnel end point address. Message 156 is sent to the WLAN AN 116, which forwards it to the UE as message 158. UE 100 then issues EAP Request/AKA Notification 160 towards WLAN AN 116, which in turn sends the receives message to 3GPP AAA server 104 as message 164.

In message 162 The 3GPP AAA Server 104 sends the EAP Success message to WLAN AN 116 (perhaps preceded by an EAP Notification, as explained in relation to message 158). If some extra keying material was generated for WLAN technology specific confidentiality and/or integrity protection then the 3GPP AAA Server 104 can include this keying material in the underlying AAA protocol message (i.e. not at the EAP level). The WLAN AN 116 stores the keying material to be used in communication with the authenticated WLAN UE 100. If the support of tunnel based multiple PDN connection is sent towards the UE 100 in message 156, the 3GPP AAA Server 104 can include a confirmation to the WLAN AN 116 at the AAA protocol attribute level, not within EAP. EAP success is reported to the UE 100 in message 166, and the keying material is stored in AAA server 104 in step 168.

It should be understood that by providing the information in message 162 to the WLAN AN 116, 3GPP AAA server 104 provides a mechanism to allow for the tear down of the PDN connection.

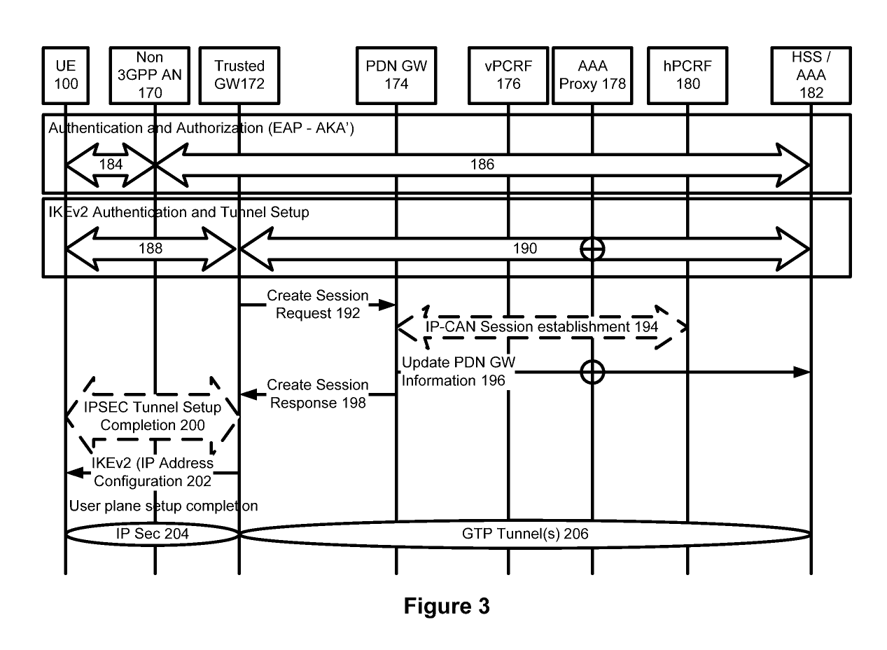

FIG. 3 is a call flow diagram that illustrates details of a call flow similar to that defined in 3GPP TS 23.402 as the un-trusted non-3GPP access initial attachment procedure. Special attention is drawn to the following observations:
The UE 100 need not perform ePDG selection. The received tunnel end point address can be used as network address of the tunnel based protocol procedure;
The first IP address allocated by the TWAN may be used as NSWO traffic; and
As both TWAN and the UE 100 has received the mPDN support indicator from the 3GPP AAA, a per PDN connection based tunnel can be setup by the UE. For instance, if IPSec is used as the tunnel based protocol, Null encryption and Null integrity can be used for the Child-SA creation procedure.

In FIG. 1, the UE and a non-3GPP IP Access network 170 exchange Authentication and Authorization information such as EAP-AKA′ messages in connection 184. These messages are relayed through connection 186 to the HSS/AAA server 182. The UE 100 also creates a connection 188 with a trusted gateway 172, with which it exchanges IKEv2 Authentication and Tunnel setup information. The trusted gateway 172 exchanged the authentication and authorization information with the HSS/AAA 182, optionally through AAA proxy 178.

Upon setup of the tunnel, the Trusted gateway 172 issues a session creation request 192 to the PDS GW 174, Upon receive of request 192, PDN gateway 174 initiates a n IP-CAN session establishment procedure 194 with hPCRF 180. The PDN Gateway then exchanges information with the HSS/AAA server 182, optionally using AAA Proxy 178, to update the PDN GW information 196. The response 198, to the create session request 192, is sent from PDN GW 174 to the trusted GW 172, allowing the EU 100 and the trusted GW to complete the IPSEC tunnel setup in step 200. the IKEv2 IP address configuration information is provided to the UE 100 by the trusted GW 172 in step 202. At this point, an IPSec tunnel is created between the UE 100 and the Trusted GW 172, and the desired number of GTP tunnels 206 between the Trusted GW 172 and the PDN GW 174 are created to complete the user plane setup.

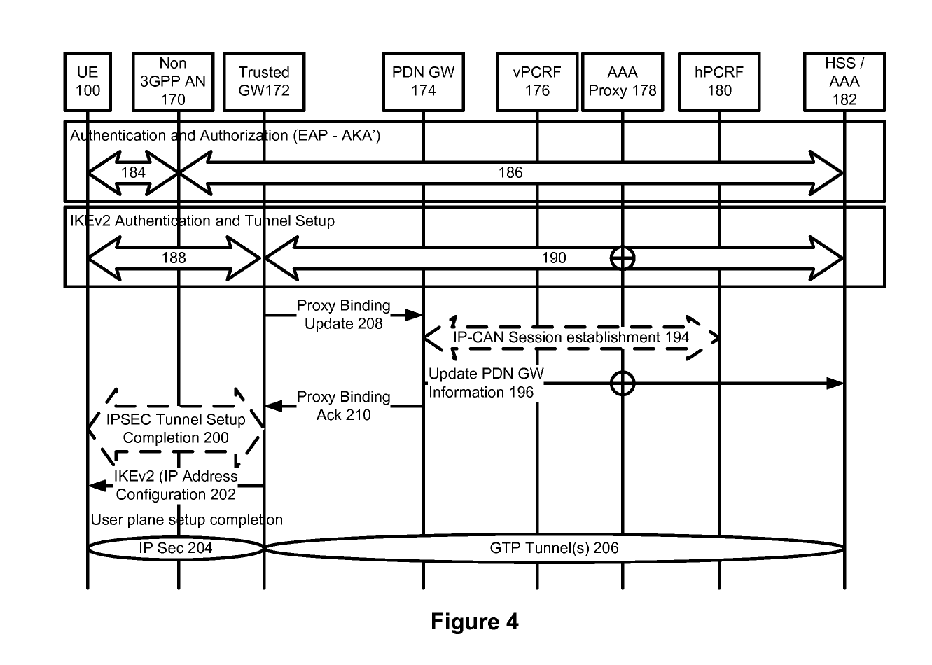

FIG. 4 provides an alternate call flow to that of FIG. 3. Where in FIG. 3 the initial attach procedure relied upon GTRP S2a, the initial attach procedure of FIG. 4 makes use of PMIP S2a. As in FIG. 3, the Authentication and Authorization (EAP-AKA′) of 184 and 86, along with the IKEv2 Authentication and Tunnel setup of 188 and 190 are performed. In step 208, a Proxy Binding Update is issued by the Trusted GW 172 to the PDN GW 174. The IP-CAN session establishment 194 and PDN GW information update 196 are again performed, leading to the proxy binding update acknowledgement 210 from the PDN GW 174 to the Trusted GW 172. The process then returns to steps 200 through 206 as discussed above.

Those skilled in the art will appreciate that the above described methods may allow for multiple PDN connections over a trusted WLAN access network.

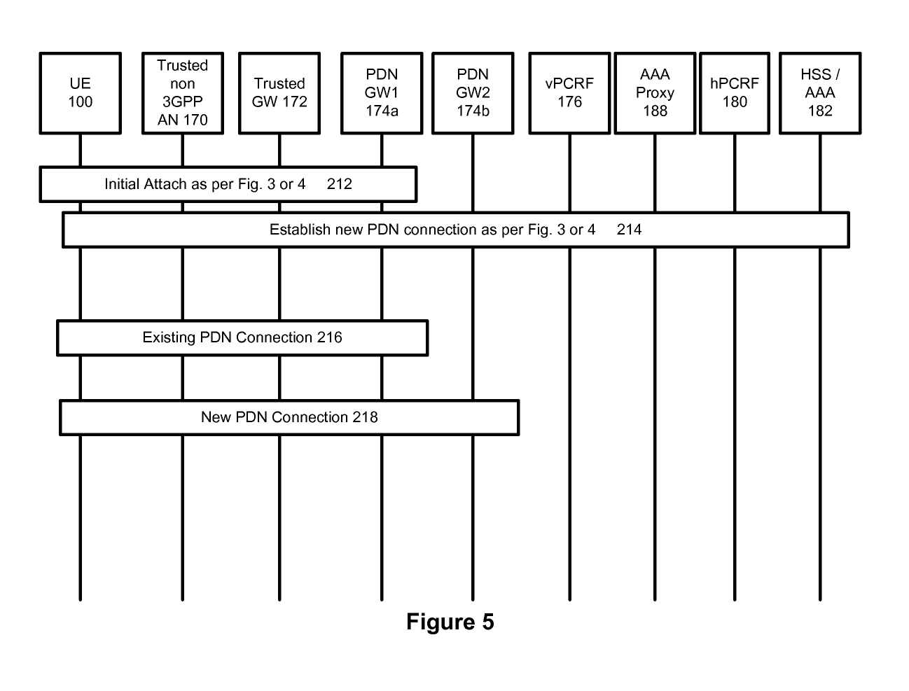

In a roaming situation, the call flow of FIG. 5 can be employed. As illustrated in FIG. 5, a UE 100 performs an initial attach procedure, such as the one illustrated in either of FIG. 3 or 4, in step 212 with a first PDN GW 174a. This is followed by the establishment of PDN connections using the methods of FIG. 3 or 4 between the UE 100 and the HSS/AAA 182 in step 214. The first PDN connection 216 is set between the UE and the PDN GW 1 174a. If the UE 100 is sufficiently mobile between PDN connection establishments, a second PDN connection 218 can be formed using the same call flows between the UE 100 and PDN GW 174b.

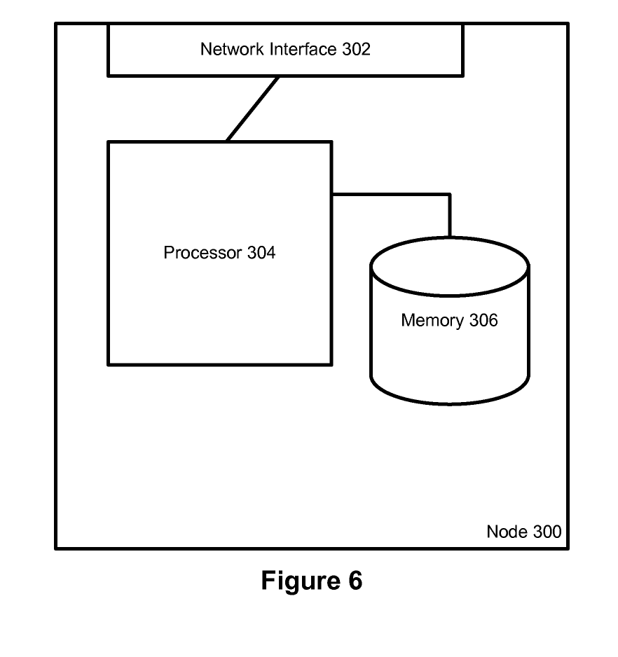

FIG. 6 illustrates a node 300 having a network interface 302, a processor 304 and a memory 306. The memory can be used to store records, as well as to store instructions for execution by the processor. The stored instructions can be used to program the processor to carry out the methods discussed above with respect to the call flow diagrams. This figure should be understood to be able to represent any of the nodes in question, including the 3GPP AAA server.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method for configuring access to a Third Generation Partnership Project (3GPP) compliant packet data network by a terminal device connecting through a trusted non-3GPP access network, the method comprising:
receiving, over a communication interface, from a node in the trusted non-3GPP access network, an indication that the trusted non-3GPP access network supports the establishment of a plurality of connections between the terminal device and a packet data network;
receiving, over the communication interface, from the terminal device an indication that the terminal device supports a plurality of connections to the packet data network;
authenticating the terminal device for access to the packet data network;
transmitting, over the communication interface, to the terminal device an indication of network support for a plurality of packet data network over the trusted non-3GPP access network; and
transmitting, over the communication interface, to the node in the trusted non-3GPP access network an indication of a decision to support the establishment of a plurality of connections between the terminal device and a packet data network over the trusted non-3GPP access network.

2. The method of claim 1 wherein the terminal device is a User Equipment device.

3. The method of claim 1 wherein the trusted non-3GPP access network is a Wi-Fi based network.

4. The method of claim 1 wherein the received indication form the node in the trusted non-3GPP access network is an indication provided as part of a Diameter/RADIUS message.

5. The method of claim 1 wherein the indication received from the terminal device is received in an Extensible Authentication Protocol (EAP) message.

6. The method of claim 5 wherein the EAP message is an Extensible Authentication Protocol (EAP) Authentication and Key Agreement challenge message.

7. The method of claim 1 wherein the indication transmitted to the terminal device is transmitted in an Extensible Authentication Protocol (EAP) Notification message.

8. The method of claim 1 wherein the indication transmitted to the node in the trusted non 3-GPP access network is transmitted in a Diameter/RADIUS success message.

9. The method of claim 1 wherein the indication received from the terminal device is received in a request to establish a connection to the packet data network, and wherein the step of authenticating is performed in response to the receipt of the request to establish the connection.

10. The method of claim 9 further including the steps of:
receiving from the terminal device a subsequent request to establish a connection to the packet data network;
updating a packet data network gateway in response to the received subsequent request; and
transmitting towards the terminal device an authentication for use in establishing a subsequent connection to the packet data network while an initial connection to the packet data network is active.

11. An Authentication Authorization and Accounting server for configuring access to a method for configuring access to a Third Generation Partnership Project (3GPP) compliant packet data network by a terminal device connecting through a trusted non-3GPP access network, the server comprising:
a network interface for communicating with nodes in the trusted non-3GPP access network;
a processor for executing stored instructions; and
a memory for storing instructions that when executed by the processor cause the Authentication Authorization and Accounting server to:
determine that a communication received from a first node in the trusted non-3GPP access network includes an indication that the trusted non-3GPP access network supports the establishment of a plurality of connections between the terminal device and a packet data network,
determine that a communication received from the terminal device includes an indication that the terminal device supports a plurality of connections to the packet data network,
authenticate the terminal device for access to the packet data network,
transmit to the terminal device over the network interface an authentication result including an indication of network support for a plurality of packet data network; and
transmit to the first node an indication of a decision to support the establishment of a plurality of connections between the terminal device and the packet data network over the trusted non-3GPP access network.

12. The server of claim 11 wherein the terminal device is a user equipment device.

13. The server of claim 11 wherein the trusted non-3GPP access network is a Wi-Fi based network.

14. The server of claim 11 wherein the memory further includes instructions that when executed by the processor cause the server to:
determine that a subsequent communication received from the terminal device, includes a subsequent request to establish a connection to the packet data network,
transmit an update message towards a packet data network gateway in response to the received subsequent request, and
transmit towards the terminal device an authentication for use in establishing a subsequent concurrent connection to the packet data network.
